(19) United States
(12) Patent Application Publication
(10) Pub. No.: US 2016/0104949 A1
(43) Pub. Date: Apr. 14, 2016

(54) SHIELD UNIT

(71) Applicant: Yazaki Corporation, Tokyo (JP)

(72) Inventor: Junya HIGASHI, Shizuoka (JP)

(73) Assignee: Yazaki Corporation, Tokyo (JP)

(21) Appl. No.: 14/973,889

(22) Filed: Dec. 18, 2015

Related U.S. Application Data
(63) Continuation of application No. PCT/JP2014/065922, filed on Jun. 16, 2014.

(30) Foreign Application Priority Data
Jun. 19, 2013 (JP) 2013-128526

(51) Int. Cl. H01R 4/18; H01R 13/24; H01R 4/30; H01R 24/56

(52) U.S. Cl. CPC H01R 4/18; H01R 24/56; H01R 13/2407; H01R 4/30

(57) ABSTRACT

A shield unit is formed such that each divided piece of a shield member, which is inserted through each slit of a shield shell and pulled out therefrom, is crimped together with a corresponding extension piece of the shield shell and crimped onto the shield shell. At that time, the outer surface of the divided piece slides on the corner at the outer edge of the slit to scrape the oxide layer off the surface of the divided piece. Each divided piece of the shield member is crimped together with each folded portion from the extension piece of the shield shell and crimped on a base of the shield shell, thereby electrically connecting the outer surface of each divided piece with the aluminum surface exposed to the base with excellent electrical conductivity.

### CROSS REFERENCE TO RELATED APPLICATIONS

This application is a continuation of International Application No. PCT/JP2014/065922, filed Jun. 16, 2014, and based upon and claims the benefit of priority from Japanese Patent Application No. 2013-128526, filed Jun. 19, 2013, the entire contents of all of which are incorporated herein by reference.

### BACKGROUND

1. Technical Field

The present invention relates to a shield unit constructed by connecting a shield shell to an open end of a shield member.

2. Related Art

A shield cable that handles a high voltage for an electric vehicle (EV) or a hybrid electric vehicle (HEV) etc. is provided with a shield unit electrically connected to a shield case. The shield unit includes a shield member, such as a braided wire covering a bundle of wires, and a shield shell connected to an open end of the shield member. When the shield shell is fixed to the shield case connected to ground, the shield member is electrically conducted to the shield case through the shield shell, and the bundle of wires covered with the shield member functions as a shield cable having a shielding property against high frequency noises.

For a connection between the shield member and the shield shell, there is frequently employed a method including the steps of: covering a cylindrical part of the shield shell with an end of the shield member, and fixing the shield member together with the shield shell with use of a crimping ring.

In contrast, the applicant of the invention has proposed, in order to simplify the operation of assembling the shield member to the shield shell, a method including the steps of: forming a folded part in a cylindrical open end of the shield shell; inserting the open end of the shield member into the folded part; and crimping the folded part to the cylindrical portion of the shield shell together with the open end of the shield member, thereby crimping the shield member onto the cylindrical portion of the shield shell (see JP 2010-153144 A).

### SUMMARY

According to the above-mentioned previous proposal of the applicant, the folded portion of the shield shell can be readily crimped onto the cylindrical portion of the shield shell together with the open end of the shield member by means of a jig such as a die, and additionally, the structure can be simplified to promote its light-weighting or cost-reduction of components.

When crimping the shield member onto the cylindrical portion of the shield shell by this proposed method, the open end of the shield member has to be expanded or diameter-enlarged so as to match an opening dimension of the folded portion, in advance of inserting the shield member into the folded portion of the shield shell. Then, it is important to expand or diameter-enlarge the shield member while paying attention to an occurrence of knitting unevenness in the shield member formed by a braided wire or thickness unevenness in the shield member formed by a thin plate.

Under such a situation as mentioned above, an object of the present invention is to provide a shield unit which can improve the workability in swaging the open end of the shield member to the shield shell to crimp the shield member on the shield shell.

In order to attain the above object, a shield unit according to an aspect of the present invention includes a cylindrical shield member having electrical conductivity, and an annular shield shell made of metal and connected to an open end of the shield member. The shield member includes a plurality of divided pieces obtained by dividing the open end into multiple portions in a circumferential direction of the shield member. The shield shell is provided with a plurality of slits into which the divided pieces are to be inserted and which are arranged, between an outer peripheral edge and an inner peripheral edge of the shield shell, at intervals in a circumferential direction of the shield shell. The shield shell has a plurality of extension pieces formed so as to extend from the outer peripheral edge of the shield shell. Each of the divided pieces passing through the slits is swaged together with each of the extension pieces, whereby the divided pieces are brought into pressure contact with a shield shell's portion between the outer peripheral edge and the inner peripheral edge of the shield shell.

In this constitution, since the divided pieces, which have been inserted into the slits of the shield shell and successively pulled out therefrom, are swaged together with the corresponding extension pieces of the shield shell, the divided pieces of the shield member are crimped to the shield shell's portion between the outer peripheral edge and the inner peripheral edge of the shield shell.

Suppose here, for example, the shielding member is composed of a braided wire. Under such a situation, if it is attempted to connect the shield member to the shield shell by widening meshes of braided to enlarge the diameter of the open end, the thickness of the shield member may vary depending on its position in the circumferential direction, thereby causing ineffective swaging/crimping in some places.

In contrast, in the shield unit according to the aspect of the present invention, the open end of the shield member is divided into a plurality of divided pieces without being enlarged in diameter. Then, after passing through the corresponding slit of the shield shell, each divided piece is swaged by the corresponding extension piece. For this reason, it is possible to swage the respective divided pieces by the extension pieces while maintaining the thickness of each divided piece uniformly and also possible to connect/fix the shield member and the shield shell to each other strongly.

Therefore, with elimination of the need to unfold the shield member or expand its diameter while taking care not to produce knitting unevenness or thickness unevenness therein, it is possible to improve the workability in swaging the open end of the shield member to crimp it on the shield shell.

The respective slits may be formed, at their peripheral edges, with sliding contact portions that are in slide contact with the divided pieces passing through the slits, respectively.

With this constitution, when each divided piece of the shield member passes through the slit, the divided piece slide on the peripheral edge of the slit, so that an oxide film is removed from the surface of the divided piece. In areas where the divided pieces with oxide layers removed are brought into pressure contact with the shield shell, there is ensured excellent electrical conductivity without interposing any oxide layer therebetween. Thus, it is possible to remove the oxide layer on the shield member certainly, thereby allowing a connection between the shield member and the shield shell with excellent electrical conductivity.

The shield unit according to the embodiment of the present invention may further include a case which accommodates the shield shell and is attached to a shield case for fixation. In this case, under condition that the case is attached to the shield case for fixation, a swaged portion of each extension piece of the shield shell is brought into elastic contact with the shield case.

In this constitution, when the shield shell is attached to the shield case for fixation through the case which accommodates the shield shell therein, extension pieces' portions of the shield shell, which swage the divided pieces respectively, are brought into elastic contact with the shield case. For this reason, it is possible to connect the shield shell to the shield case with excellent electrical conductivity, thereby enhancing the shielding efficiency of the shield unit for wire bundles.

The slide contact portion may have a plurality of concave portions and a plurality of convex portions formed in the edge of the slit alternately.

Since the slide contact portion formed at the inner peripheral edge of the slit has the concave portions and the convex portions arranged alternately, the removal of oxide layers from the surfaces of the divided pieces is reliably generated when the surfaces of the divided pieces are in slide contact with the slide contact portions of the slits and hence it is possible to connect the shield member and the shield shell to each other with excellent electrical conductivity.

With the shield unit according to the aspect of the present invention, it is possible to improve the workability in crimping the open end of the shield member to the shield shell to crimp the shield member on the shield shell.

### BRIEF DESCRIPTION OF DRAWINGS

FIG. 1 is an exploded perspective view of a shield unit according to an embodiment.

FIG. 2 is a longitudinal sectional view illustrating a step of assembling a shield shell to a shield member of FIG. 1.

FIG. 3 is a longitudinal sectional view illustrating a step following the step of FIG. 2 for assembling the shield shell to the shield member of FIG. 1.

FIG. 4 is a perspective view illustrating a state where divided pieces of the shielding member are crimped on a base of the shield shell by crimping its extension pieces.

FIG. 5 is an explanatory view of a state where a case, which accommodates the shield shell of FIG. 4 assembled to the shield member in a case body, is attached to a shield case for fixation.

FIG. 6 is a longitudinal sectional view illustrating an abutting state of the shield shell against the shield case under condition that the shield shell is accommodated in the case body of the case of FIG. 5 attached to the shield case for fixation.

FIG. 7 is a plan view illustrating a shield shell of a shield unit according to a first modification of the embodiment.

FIG. 8 is a longitudinal sectional view illustrating a state where a shield shell is assembled to a shield member of a shield unit according to a second modification of the embodiment.

### DETAILED DESCRIPTION

A shield unit according to an embodiment will be described with reference to drawings. In the following description of the drawings, identical or similar portions are indicated with the same or similar reference numerals, respectively. Nevertheless, it should be noted that the illustrated drawings are nothing but schematic and therefore, ratios of respective dimensions etc. are different from real ones.

Accordingly, specific dimensions etc. should be determined in consideration of the following description. In addition, there may be included portions whose mutual positional relationships or ratios are different from each other among the drawings.

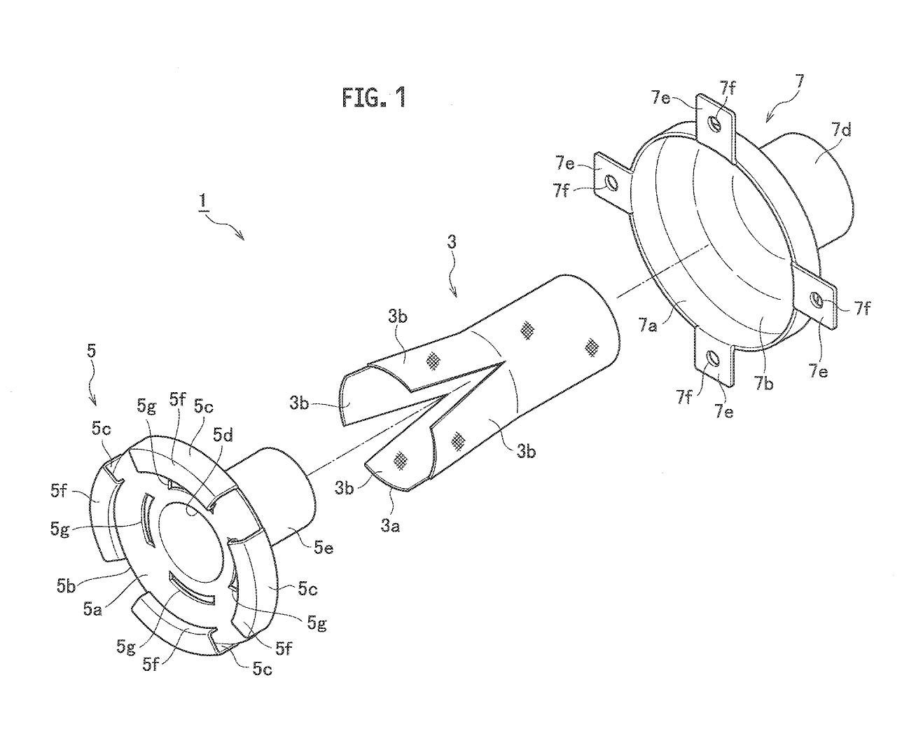

As illustrated in FIG. 1, a shield unit 1 according to an embodiment is utilized to construct a shield cable (not illustrated) by covering a plurality of wire bundles (not illustrated). The shield unit 1 includes a cylindrical shield member 3 made by an aluminum braided wire covering the wire bundles, a metal shield shell 5 connected to the shield member 3, and a metal case 7 attached to an outside of the shield shell 5 connecting the shield member 3.

In the shield unit 1 according to the embodiment, by making four incisions in one open end 3a of the shield member 3, it is circumferentially divided into four divided pieces 3b. Incidentally, instead of making the incisions in the one end, the braided wire may be assembled so that the member's portion on the side of the open end 3a is divided into four divided pieces 3b.

The shield shell 5 includes an annular base 5a, four extension pieces 5c extends from an outer peripheral edge 5b of the base 5a in four directions, and a cylindrical portion 5c extending from an inner peripheral edge 5d of the base 5a. The shield unit 1 according to the embodiment will be described by an example in which the shield shell 5 is in the form of an annular member. However, the shield shell 5 is not limited only to a member having a circular contour and therefore, it may be formed so as to have a variety of annular contours, such as rectangular, square, polygonal, oval contour, and so on. The extension pieces 5c are formed, at their leading end, with inward folded portions 5f, respectively. In the base 5a, the inner peripheral edge 5d and the cylindrical portion 5e are formed to have diameters slightly smaller than the diameter of the shield member 3.

Between the outer peripheral edge 5b and the inner peripheral edge 5d of the base 5a, four slits 5g corresponding to the respective extension pieces 5c are formed at intervals in the circumferential direction of the base 5a so as to penetrate through the base 5a. Each slit 5g has a frontage allowing the divided piece 3b of the shield member 3 to be inserted thereinto.

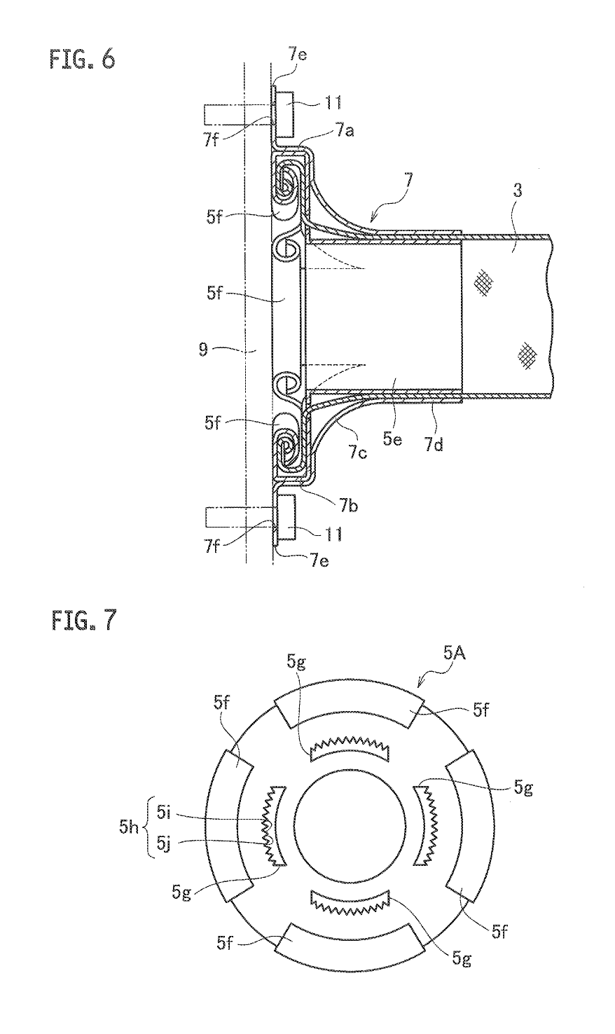

The case 7 includes a bottomed cylindrical case body 7a covering the base 5a and the respective extension pieces 5c of the shield shell 5, and a cylindrical portion 7d connected to a bottom surface 7b of the case body 7a through a tapered cylindrical portion 7c (see FIG. 6). The cylindrical portion 7d is formed with a diameter slightly larger than the shield member 3.

At the open end of the case body 7a, four attachment pieces 7e are formed so as to extend in four radial directions of the case body 7a. Each attachment piece 7a is provided with an attachment hole 7f into which a bolt or the like is inserted.

Next, the procedure of assembling the shield shell 5 to the open end 3a of the shield member 3 will be described. First, the divided pieces 3b of the shield member 3 are inserted from the side of the cylindrical portion 5e into the slits 5g and then, respective leading ends of the divided pieces 3b are pulled out to the side of the extension pieces 5c. Consequently, in the shield shell 5, its outer circumferential surface of the cylindrical portion 5e is covered with a portion of the shield member 3 exclusive of the divided pieces 3b.

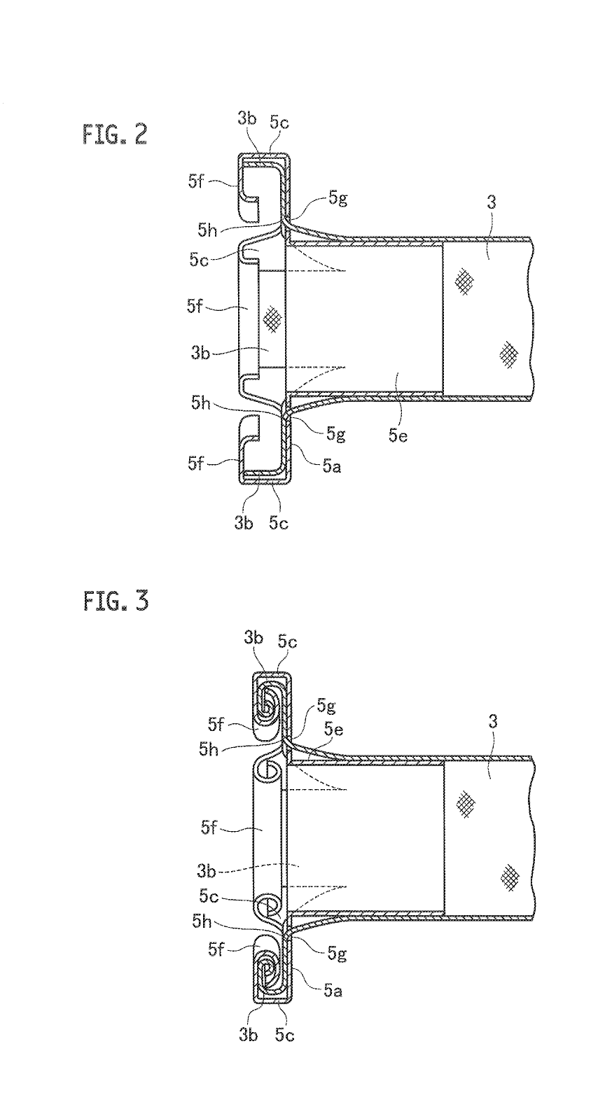

Here, when pulling out the leading ends of the divided pieces 3b inserted into the slits 5g, the outer surface of each divided piece 3b slidingly contacts a corner 5h as an outer peripheral sliding contact portion of the slit 5g, which is positioned closer to the outer peripheral edge 5b of the base 5a, as illustrated in FIG. 2. Owing to this sliding contact, an oxide layer (not illustrated) on the outer surface of each divided piece 3b is scraped off by the corner 5h and hence an aluminum background of the divided piece is exposed.

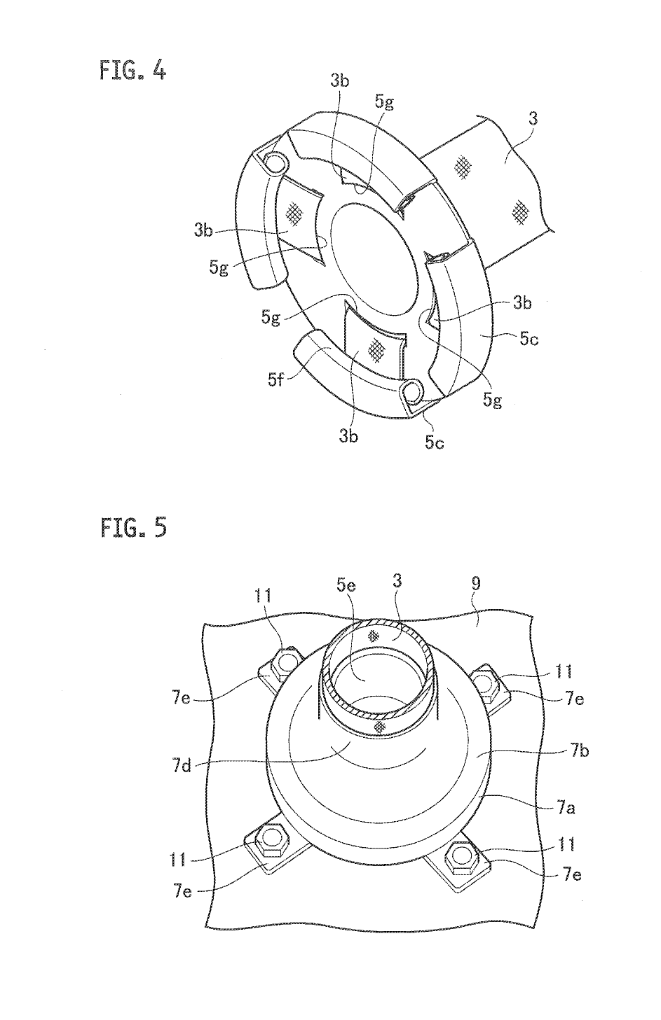

Then, after inserting the leading ends of the respective divided pieces 3b into the folded portions 5f of the extending pieces 5c, the divided pieces 3b of the shield member 3 are folded inwardly and crimped together with the folded portions 5f of the extending pieces 5c, as illustrated in FIG. 3. Thus, the outer surface of each divided piece 3b with its aluminum background exposed is brought into pressure contact with the base 5a of the shield shell 5, that is, a shell's portion between the outer peripheral edge 5b and the inner peripheral edge 5d, thereby realizing a state illustrated in FIG. 4. Therefore, the shield member 3 and the shield shell 5 are connected to each other with excellent electric conductivity.

In this state, then, the cylindrical portion 5e of the shield shell 5 and the shield member 3 covering the cylindrical portion 5e are inserted into the cylindrical portion 7d of the case 7, and hence the base 5a and the extension pieces 5c of the shield shell 5 are accommodated in the case body 7a. Then, as illustrated in FIG. 5, by allowing the respective attachment pieces 7e of the case 7 to abut against a shield case 9, the case 7 is attached to the shield case 9 by bolts 11 or others for fixation, which are inserted into the attachment holes 7f of the attachment pieces 7e.

In this way, as illustrated in FIG. 6, the base 5a of the shield shell 5 in contact with the bottom surface 7b of the case body 7a is pressed from the bottom surface 7b. Then, the folded portions 5f of the extension pieces 5c of the shield shell 5 are crimped together with the divided pieces 3b of the shield member 3, and brought into pressure contact with the base 5a, thereby accomplishing their elastic contact with the shield case 9. Thus, the shield shell 5 and the shield case 9 are connected to each other with excellent electric conductivity, so that the shield unit 1 functions as a shield cable covering the wire bundles.

As described above, with the shield unit 1 according to the embodiment, the open end 3a of the shield member 3 is divided into the plurality of divided pieces 3b without being enlarged in diameter. Further, by making each divided piece 3b pass through the corresponding slit 5g, each divided piece 3b is crimped together with the folded portion 5f of the corresponding extension piece 5c and crimped on the base 5a. Accordingly, since the respective divided pieces 3b are crimped by the extension pieces 5c while maintaining the thickness of each divided piece 3b uniformly, it is possible to connect and fix the shield member 3 to the shield shell 5 solidly.

Therefore, with elimination of the need to unfold the shield member 3 or enlarge its diameter while taking care not to produce knitting unevenness or thickness unevenness therein, it is possible to improve the workability in crimping the open end 3a of the shield member 3 to crimp it on the shield shell 5.

Note that the shield unit 1 according to the embodiment is constructed in a manner that, when the respective divided pieces 3b of the shield member 3 are inserted into the slits 5g of the shield shell 5 and pulled out therefrom, an outer surface of each divided piece 3b slidingly contacts a corner 5h of an outer edge of the slit 5g and hence the oxide layer is scraped off from the outer surface. The construction for this purpose could be eliminated if not necessary, for example, a case of constructing the shield member 3 by a material on which an oxide layer is not deposited, e.g. copper.

However, if a shield unit is provided with such a constitution as if it were the shield unit 1 according to the embodiment and when the shield member 3 is made of e.g. aluminum, it is possible to electrically connect the outer surface of each divided piece 3b exposing its aluminum background to the base 5a with excellent electrical conductivity, by crimping each divided piece 3b of the shield member 3 together with each folded portion 5f of the extension piece 5c of the shield shell 5 and further bringing each divided piece 3 into pressure contact with the base 5a of the shield shell 5. Accordingly, since an oxide layer is reliably removed from the surface of each divided piece 3b of the shield member 3, the shield member 3 can be electrically connected to the shield shell 5 with excellent electrical conductivity.

Further, with the shield unit 1 according to the embodiment, the attachment pieces 7e of the case 7 where the base 5a of the shield shell 5 is accommodated in the case body 7a are attached to the shield case 9 by the bolts 11 for fixation, so that the clamped folded portion 5f of each extension piece 5c of the shield shell 5 is brought into elastic contact with the shield case 9. For this reason, it is possible to connect the shield shell 5 and the shield case 5 to each other with excellent electrical conductivity and also possible to enhance the shielding efficiency.

Further, for example, when the shielding member 3 is composed of a braided wire, it is often the case that, generally, meshes of the braided wire are widened to enlarge the diameter of the open end in order to connect the shield member 3 to the shield shell 5. However, if it is done in this way, the thickness of the shield member 3 varies depending on its position in the circumferential direction, thereby causing the possibility that the shield member 3 in some places is insufficiently crimped to the shield shell 5 for fixation.

In contrast, with the shield unit 1 according to the embodiment, the open end 3a of the shield member 3 is divided into the plurality of divided pieces 3b without being enlarged in diameter and thereafter, each divided piece 3b is crimped by the corresponding extension piece 5c of the shield shell 5. Therefore, the respective divided pieces 3b can be crimped by the extension pieces 5c while maintaining the thickness of each divided piece 3b uniformly. Thus, it is possible to connect and fix the shield member 3 and the shield shell 5 to each other strongly.

Incidentally, like a shield shell 5A in the shield unit according to a first modification of the embodiment, which is illustrated in FIG. 7, the corner 5h of each slit 5g may include a shaving groove having a plurality of concave portions 5i and a plurality of convex portions 5j arranged alternately. Thus, since the oxide layer is effectively scraped off when the outer surface of each divided piece 3b of the shield member 3 slidingly contacts the corner 5h, it is possible to connect the shield member 3 and the shield shell 5A with excellent electrical conductivity.

Moreover, the shaving groove having the concave portions 5i and the convex portions 5j may be also formed in the corner of the inner peripheral edge of each slit 5g so that the oxide layer is scraped off from the surface of each divided piece 3b by the concave and convex portions in sliding contact with the divided piece 3b of the shield member 3.

Furthermore, in the shield unit 1 according to the embodiment, it is constructed so as to allow each divided piece 3b of the shield member 3, which is overlaid outside the cylindrical portion 5e of the shield shell 5, to pass from the side of the cylindrical portion 5e to the side of the extension pieces 5c through the slit 5g of the base 5a.

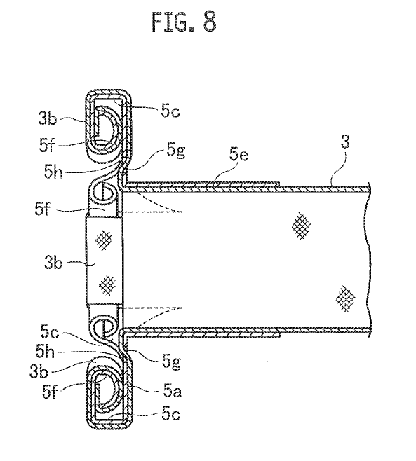

However, as illustrated in FIG. 8, a shield unit according to a second modification of the embodiment may be constructed so as to pull out each divided piece 3b from the cylindrical portion 5e into which the shield member 3 is inserted and subsequently allow each pulled-out divided piece 3b to pass from the side of the extension pieces 5c to the side of the cylindrical portion 5e through the slit 5g of the shield shell 5. In such a case, the leading ends of the divided pieces 3b will be wound up into the folded portions 5f through the outside of the extension pieces 5c and subsequently, each divided piece 3b will be crimped together with the folded portion 5f and brought into pressure contact with the base 5s.

Note that, like the embodiment described with reference to FIGS. 1 to 7, if the shield unit is constructed so as to allow the divided pieces 3b of the shield member 3, which are overlaid outside the cylindrical portion 5e of the shield shell 5, to pass from the side of the cylindrical portion 5e to the side of the extension pieces 5c through the slits 5g of the base 5a, then the shield member 3 is brought into pressure contact with the cylindrical portion 5e of the shield shell 5 by the cylindrical portion 7d of the case 7, thereby increasing the area of press-contact portions for both elements. For this reason, the embodiment illustrated in FIGS. 1 to 7 is more advantageous in view of connecting the shield member 3 and the shield shell 5 to each other with excellent electrical conductivity.

Additionally, the division number of the divided pieces 3b of the shield member 3 and the numbers or arrangement of the extension pieces 5c and the slits 5g provided in the shield shell 5 correspondingly are optional without being limited to the content of the embodiment. Furthermore, the shield unit 1 may be composed of the shield member 3 and the shield shell 5, providing that the case 7 is not used to attach the shield shell 5 to the shield case 9 for fixation so that the shield shell 5 is directly attached to the shield case 9 for fixation.

What is claimed is:

1. A shield unit, comprising:
a cylindrical shield member having electrical conductivity; and
an annular shield shell made of metal and connected to an open end of the shield member,
the shield member comprising a plurality of divided pieces obtained by dividing the open end into multiple portions in a circumferential direction of the shield member,
the shield shell provided with a plurality of slits into which the divided pieces are to be inserted and which are arranged, between an outer peripheral edge and an inner peripheral edge of the shield shell, at intervals in a circumferential direction of the shield shell,
the shield shell having a plurality of extension pieces formed so as to extend from the outer peripheral edge of the shield shell, wherein
each of the divided pieces passing through the slits is crimped together with each of the extension pieces, whereby the divided pieces are brought into pressure contact with a shield shell's portion between the outer peripheral edge and the inner peripheral edge of the shield shell.

2. The shield unit of claim 1, wherein
the respective slits are formed, at peripheral edges thereof, with sliding contact portions that are in slide contact with the divided pieces passing through the slits, respectively.

3. The shield unit of claim 1, further comprising
a case which accommodates the shield shell and is attached to a shield case for fixation, wherein
each crimped portion of the extension pieces of the shield shell is brought into elastic contact with the shield case under a condition that the case is attached to the shield case for fixation.

4. The shield unit of claim 1, wherein
the slide contact portion has a plurality of concave portions and a plurality of convex portions formed in the edge of the slit alternately.
